(19) United States
(12) Patent Application Publication
(10) Pub. No.: US 2008/0112647 A1
(43) Pub. Date: May 15, 2008

(54) SYSTEMS AND METHODS FOR RESIZING MULTIMEDIA DATA

(76) Inventor: Ke-Chiang Chu, Saratoga, CA (US)

Correspondence Address: FLIESLER MEYER LLP, 650 CALIFORNIA STREET, 14TH FLOOR, SAN FRANCISCO, CA, 94108, US

(21) Appl. No.: 11/560,230

(22) Filed: Nov. 15, 2006

(51) Int. Cl. G06K 9/32

(52) U.S. Cl. 382/298

(57) ABSTRACT

Systems and methods for resizing data that provides higher quality results while using fewer resources than traditional methods. In one embodiment disclosed herein, a nearest neighborhood technique is used to compute data that can be used to generate target data. The resizing method is ideal for use in mobile devices, where video and audio data may need to be resized or resampled, but memory and processing power are scarce.

### FIELD OF THE INVENTION

The present invention relates to the resizing of multimedia data, and more particularly to a method of efficiently resizing multimedia data.

### BACKGROUND OF THE INVENTION

With the proliferation of mobile audio and video devices, it is frequently necessary to change the size of video or image data or resample audio data. This might be done because a video device has a display size different from the size of the source data, or because the device has limited bandwidth to receive streaming audio or video. Techniques for resizing images exist in the prior art, but in order to achieve high-quality results, a large amount of memory and processing power is necessary, resources that are typically unavailable on mobile devices.

First order linear interpolation is the simplest and most popular method of resizing one-dimensional multimedia data. The method works by estimating the value of data at a particular point based on the value at surrounding points. In order to estimate the value of y at x between (x₁, y₁) and (x₂, y₂), one can use the following first order linear filter (1.0) which assumes a linear relationship among (x, y), (x₁, y₁), and (x₂, y₂).

$$y = {y}_{1} + \frac{( x - {x}_{1} ) ( {y}_{2} - {y}_{1} )}{( {x}_{2} - {x}_{1} )} \qquad ( 1.0 )$$

### Where x₁≦x<x₂, and y₁<y<y₂.

The solution to this equation is simple. For the one-dimension filtering, the calculation for each target data point takes one multiplication, one division, and four additions. However, the output quality of this simple linear interpolation is usually not good.

In order to improve the output quality of the simple linear interpolation, a higher order polynomial filter is used for re-sizing the one-dimension multimedia data. As an example, an n^{th} order polynomial filter (2.0)f(x) can be used.

f(x)=aₙxⁿ+aₙ₋₁xⁿ⁻¹+ . . . +a₂x²+a₁x+a₀, (2.0)

with yᵢ=f(xᵢ) and where aₙ, aₙ₋₁, . . . , a₂, a₁, a₀ are constants, and 0≦i≦n. The system of linear equations can be written in the following matrix form.

$$[ \begin{matrix}{x}_{0}^{n} & {x}_{0}^{n - 1} & {x}_{0}^{n - 2} & ⋯ & {x}_{0} & 1 \\ {x}_{1}^{n} & {x}_{1}^{n - 1} & {x}_{1}^{n - 2} & ⋯ & {x}_{1} & 1 \\ ⋮ & ⋮ & ⋮ & & ⋮ & ⋮ \\ {x}_{n - 1}^{n} & {x}_{n - 1}^{n - 1} & {x}_{n - 1}^{n - 2} & ⋯ & {x}_{n - 1} & 1 \\ {x}_{n}^{n} & {x}_{n}^{n - 1} & {x}_{n}^{n - 2} & ⋯ & {x}_{n} & 1\end{matrix} ] [ \begin{matrix}{a}_{n} \\ {a}_{n - 1} \\ ⋮ \\ {a}_{1} \\ {a}_{0}\end{matrix} ] = [ \begin{matrix}{y}_{0} \\ {y}_{1} \\ ⋮ \\ {y}_{n - 1} \\ {y}_{n}\end{matrix} ]$$

For each target data component of the one-dimension polynomial interpolation, it takes n multiplications and (n-1) additions. For a high quality output, the length of the polynomial can be from 300 to 3000 operations long. Therefore, the calculation of the polynomial interpolation can be quite expensive.

The concept of the one-dimension interpolation can easily be extended to two-dimension multimedia applications for re-sizing the video and still image data. As an example, the linear interpolation for one-dimension filter can be applied to two-dimension data with a bilinear interpolation as described below.

Suppose it desirable to estimate the value of function f at point (x, y). Assuming the values of f at the four points, f(x₁, y₁), f(x₁, y₂), f(x₂, y₁), and f(x₂, y₂) are known, and x₁≦x<x₂, and y₁≦y<y₂, the linear interpolation in the x-dimension yields the following

$$f ( x , {y}_{1} ) \approx \frac{{x}_{2} - x}{{x}_{2} - {x}_{1}} f ( {x}_{1} , {y}_{1} ) + \frac{x - {x}_{1}}{{x}_{2} - {x}_{1}} f ( {x}_{2} , {y}_{1} )$$

$$and$$

$$f ( x , {y}_{2} ) \approx \frac{{x}_{2} - x}{{x}_{2} - {x}_{1}} f ( {x}_{1} , {y}_{2} ) + \frac{x - {x}_{1}}{{x}_{2} - {x}_{1}} f ( {x}_{2} , {y}_{2} ) .$$

### Interpolation in the y-dimension yields.

$$f ( x , y ) \approx \frac{{y}_{2} - y}{{y}_{2} - {y}_{1}} f ( x , {y}_{1} ) + \frac{y - {y}_{1}}{{y}_{2} - {y}_{1}} f ( x , {y}_{1} )$$

Combining these results, results in the folowing:

$$f ( x , y ) \approx \frac{( {x}_{2} - x ) ( {y}_{2} - y )}{( {x}_{2} - {x}_{1} ) ( {y}_{2} - {y}_{1} )} f ( {x}_{1} , {y}_{1} ) + \frac{( x - {x}_{1} ) ( {y}_{2} - y )}{( {x}_{2} - {x}_{1} ) ( {y}_{2} - {y}_{1} )} f ( {x}_{2} , {y}_{1} ) + \frac{( {x}_{2} - x ) ( y - {y}_{1} )}{( {x}_{2} - {x}_{1} ) ( {y}_{2} - {y}_{1} )} f ( {x}_{1} , {y}_{2} ) + \frac{( x - {x}_{1} ) ( y - {y}_{1} )}{( {x}_{2} - {x}_{1} ) ( {y}_{2} - {y}_{1} )} f ( {x}_{2} , {y}_{2} )$$

For the simple bilinear interpolation, it takes 19 additions, 12 multiplications, and 4 divisions for each target data component. Obviously, the amount of the data processing for the two-dimension interpolation is much more than that of the one-dimension interpolation. In addition the output image/video quality of the simple bilinear interpolation usually is not good either.

Two-dimensional filtering is also susceptible to higher order solutions to improve quality, but those solutions require drastically larger numbers of operations, and as a result, require substantial processing power and memory.

While high order interpolation is necessary in order to achieve quality results, the use of high order interpolation techniques is impractical for portable, battery-powered, hand held devices such as cell phones, PDAs, and portable audio/video players. The memory and processing power of such mobile devices is far too limited to use high order interpolation to perform resizing in practical applications.

Accordingly, a more efficient system and method for resizing or resampling multimedia data is desirable.

### SUMMARY

The present invention provides a method for resizing data that provides higher quality results while using fewer resources than traditional methods. In one aspect of the various embodiments disclosed herein, a nearest neighborhood technique is used to compute data that can be used to generate target data. The present invention is ideal for use in mobile devices, where video and audio data may need to be resized or resampled, but memory and processing power are scarce.

### BRIEF DESCRIPTION OF THE DRAWINGS

In order to better appreciate how the above-recited and other advantages and objects of the various embodiments disclosed herein are obtained, a more particular description will be rendered by reference to specific embodiments thereof, which are illustrated in the accompanying drawings. It should be understood that these drawings depict only typical embodiments and do not limit the scope of the various embodiments of the invention disclosed herein. These specific embodiments will be described and explained with additional detail through the use of the accompanying drawings in which:

FIG. 1a is an illustration of a source image and a target image.

FIG. 1b is a flow diagram showing the calculation of target data from source data.

FIG. 2a is an illustration of the calculation of neighbor rows and columns and neighbor points.

FIG. 2b is a flow diagram showing the calculation of neighbor rows and columns and neighbor points.

FIG. 3a is an illustration of the nearest neighbor method of calculating the target data.

FIG. 3b is a flow diagram showing the calculation of a target data point using the nearest neighbor method.

FIG. 4a is an illustration of a combination of the nearest neighbor method with one-dimensional interpolation to calculate the target data.

FIG. 4b is a flow diagram showing the calculation of a target data point using a nearest neighbor method combined with one-dimensional interpolation.

FIG. 5a is an illustration of the use of the nearest neighbor approach in combination with two-dimensional interpolation to calculate the target data.

FIG. 5b is a flow diagram showing the calculation of a target data point using a nearest neighbor method combined with two-dimensional interpolation.

FIG. 6 is an illustration of a portable data system suitable for executing the resizing method.

### DETAILED DESCRIPTION

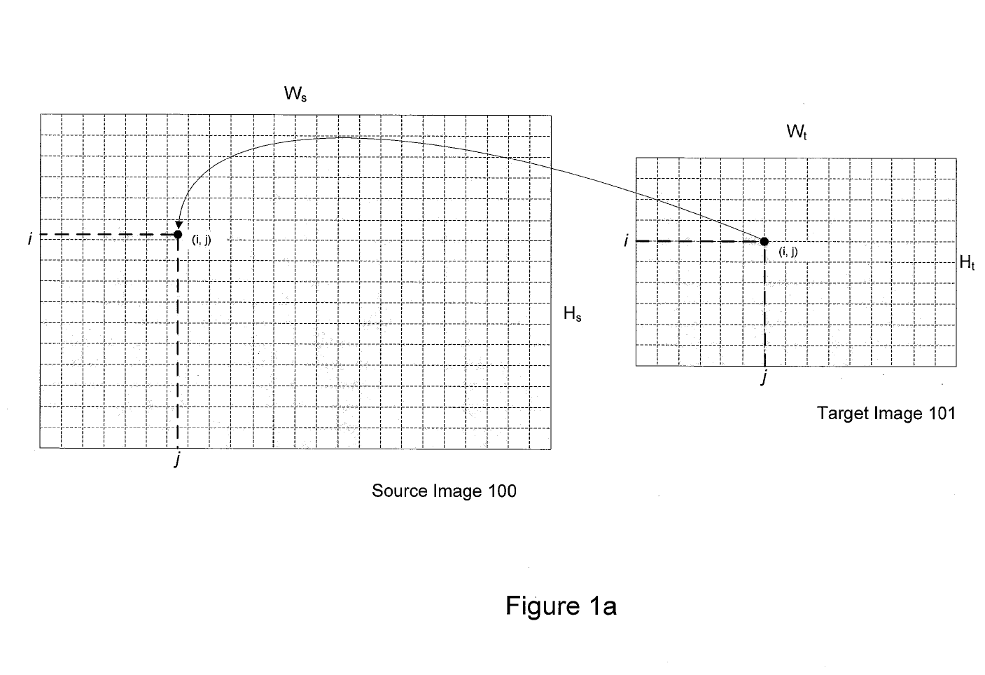

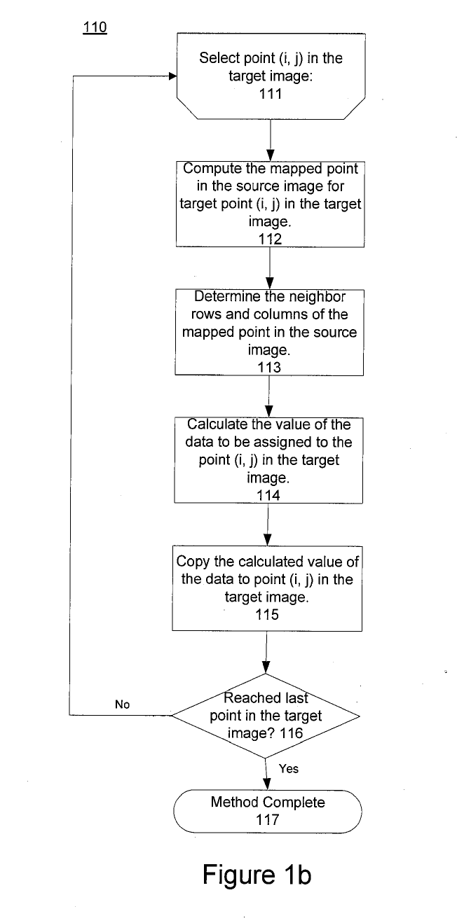

FIG. 1a illustrates an embodiment of the invention where a two-dimensional source image 100 and a two dimensional target image 101 corresponding to a device display are of different dimensions. The two-dimensional data in this embodiment might represent a still image or a single video frame that is to be resized to dimensions suitable for display on a mobile or portable device such as a PDA or cell phone.

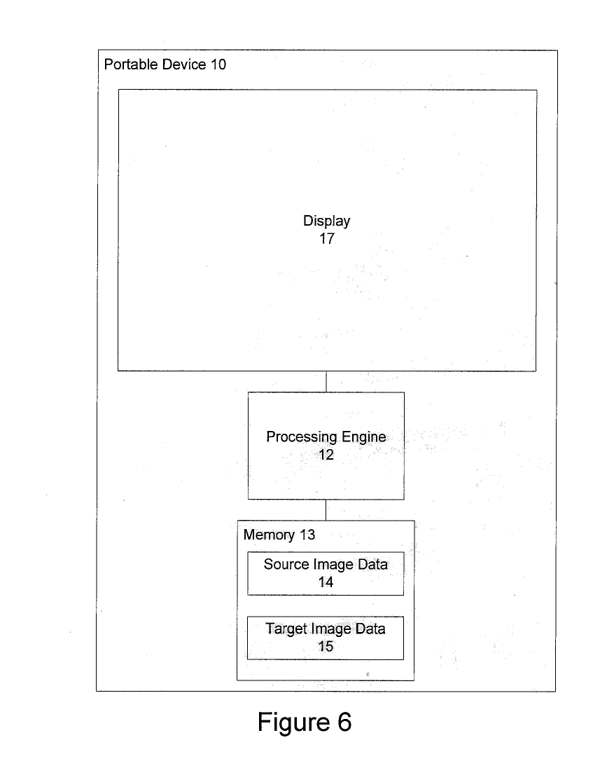

As depicted in FIG. 6, the portable device 10 preferably includes a display 17, a mix of volatile and non-volatile memory 13, and a processing engine 12 to carry out the methods described below. The processing engine 12 could be hardware, firmware, or software based, or a combination thereof. If hardware based, the processing engine 12 could include an application specific integrated circuit (ASIC), a field programmable gate array (FPGA), and/or a programmable logic device (PLD). If firmware based, the processing engine 12 could include a central processing unit (CPU) and/or a digital signal processor (DSP) with RAM, and/or ROM, and/or flash memory. If software based, the processing engine 12 could include a CPU and/or a DSP with RAM, ROM and/or flash memory and a software program stored in memory and executable by the CPU and DSP. Alternatively, the processing engine 12 could include a combination of the above, i.e., a CPU and/or a DSP with RAM, ROM and/or flash memory, and hardware accelerators, which could be combination of an ASIC, FPGA, or PLD.

It will be understood that references to the “source image” and “target image” refer to this two-dimensional data, and the use of the term “image” should be understood to be illustrative only and not to limit the present invention to working with image data.

FIG. 1a illustrates a source image 100 of width Wₛ and height Hₛ and a target image 101 of width Wₜ and height Hₜ. The source image size is the size of the image retrieved from the distribution media, i.e., flash card, OTA, etc. The target image 101 can be the physical size of the device display 17, or desired image size (fall screen, wide screen, zoom-in, etc.) requested by the user. In FIG. 1, the source image 100 is depicted as larger than the target image 101, but it will be appreciated by one of skill in the art that the methods disclosed below may operate on source and target data of any dimensions, including source data that is larger or smaller than the target data.

Both the source 100 and target 101 images are stored in a format where an element of data can be accessed by reference to a specific row i and column j. The element of data at a specific row i and column j can be succinctly referenced as (i,j), where i and j are integers. In the case of image data, a particular data element at a specific row and column would refer to the pixel at that row and column in the image. It is also possible to refer to a point in the image at non-integer valued rows and columns. It will be understood that there is no data value associated with these points, but they are simply useful for geometrically visualizing the functioning of the methods described herein.

In some embodiments of the present method, it is useful to compute a resizing ratio R, which represents the relative sizes of the source and target images. In one embodiment, the resizing ratio may be calculated based on either the relative widths or relative heights of the image. For instance, the resizing ratio may equal Wₜ/Wₛ for images that are to be displayed in a wide-screen format and Hₜ/Hₛ for images that are to be displayed in a fall-screen format. Other embodiments that calculate the resizing ratio by a different method are possible, as well as methods that use multiple resizing ratios.

FIG. 1b illustrates a preferred embodiment of a method 110 of generating a target image 101 from a source image 100. As depicted, the method 110 preferably iterates through each point (i, j) in the target image 101. In step 111, a point (i, j) in target image 101 is selected to be mapped to the source image 100. In step 112, the method 110 computes the mapped point (i, j) in the source image 100 corresponding to the point (i, j) in the target image 101. In step 113, the method computes the neighbor rows i and columns j to the mapped point (i, j) in the source image 100. In step 114, the method 110 uses the mapped point (i, j) and the neighbor rows i and columns j in the source image 100 to compute the value of the data at the point (i, j) in the target image 101. Finally, the value computed in step 114 is copied in step 115 to the target image 101 at point (i, j). In step 116, the method 110 determines whether the values for all points (i, j) in the target image 101 have been computed; if they have, the method 110 is terminated in step 117, otherwise the method 110 returns to step 111 to compute the value of the data at the next point (i, j) in the target image 101.

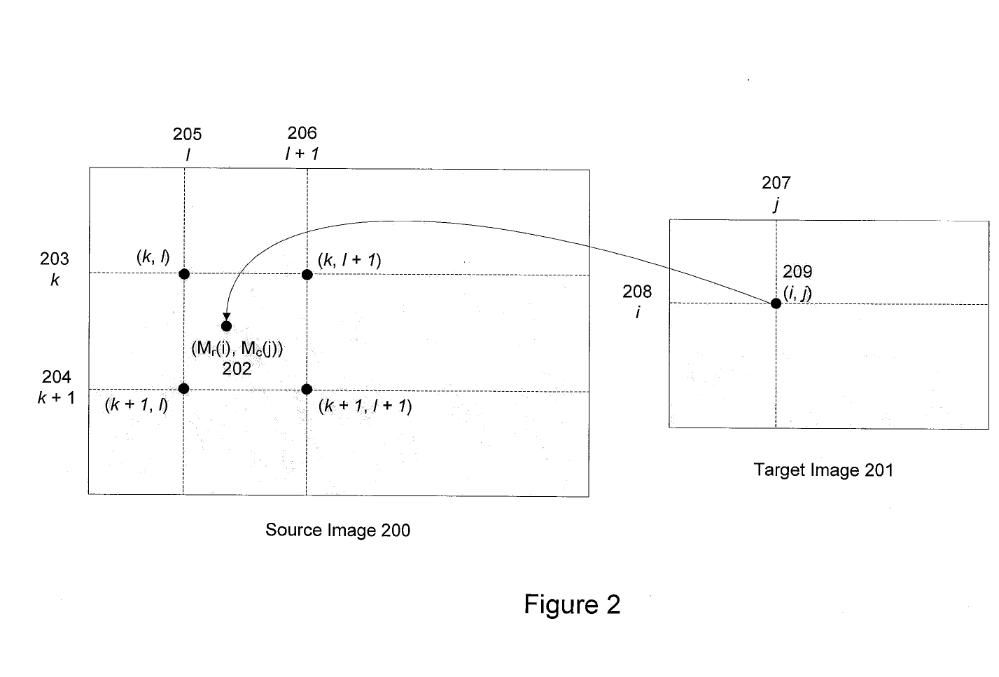

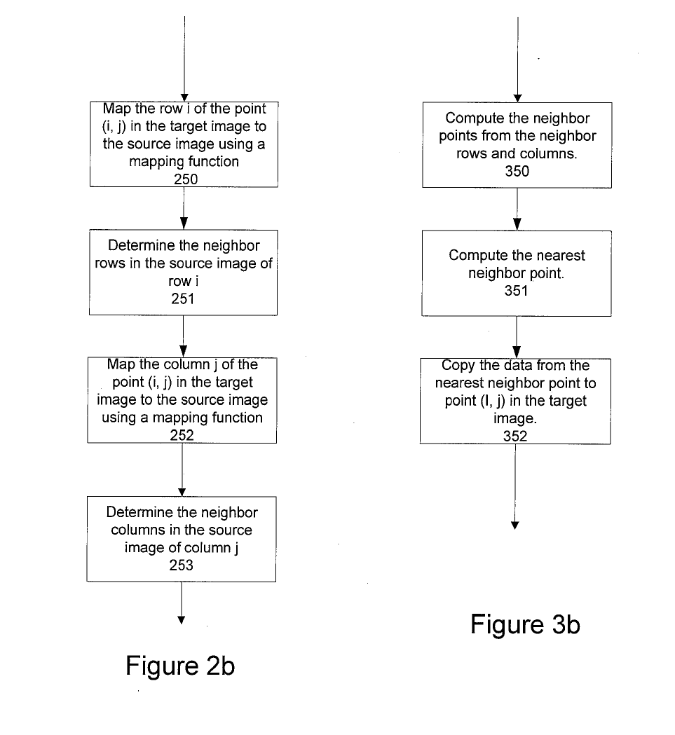

FIGS. 2a and 2b provide a more detailed illustration and discussion of steps 112 and 113 of the method 110. As depicted, FIGS. 2a and 2b illustrate the calculation of a mapped point 202 in the source image corresponding to a specific point (i, j) 209 in the target image 201, as well as the calculation of the neighbor rows 203 and 204 and neighbor columns 205 and 206 corresponding to the mapped point 202. As indicated in FIG. 2b, the neighbor rows 203 and 204 and neighbor columns 205 and 206 corresponding to the mapped point 202 are computed through the use of row and column mapping functions Mᵣ(i) and M_{c}(j).

In step 250, the row mapping function Mᵣ(i) takes a row i 208 from the target image 201 and maps it to a value between two rows k 203 and k+1 204 in the source image 200. The row mapping function can be of any functional form, including a simple linear function. In a preferred embodiment, the row mapping function Mᵣ(i) is defined by equation 3.0 as follows:

Mᵣ(i)==((2*i+1)*maparray[R*16−1])/8192 (3.0)

where maparray[ ] is an array of constants whose value can be expressed in C syntax as maparray[ ]={65536, 65536, 32768, 16384, 13107, 10922, 9362, 8192, 7281, 6553, 5957, 5461, 5041, 4681, 4369, 4096}.

In order to compute the value of Mᵣ(i), the expression 16R−1 is used to lookup a value in the array maparray[ ]. For instance, if R is equal to 0.25, 16R−1 will be equal to 3, and the corresponding value in maparray[ ] will be 16384 (maparray[ ] is indexed starting from zero, so this is the fourth value in the array). If 16R−1 is a non-integer, it will be rounded down to an integer. The value from maparray[ ] will be multiplied by (2*i+1), and the result will be divided by 8192.

With the value for Mᵣ(i) determined, the corresponding neighbor rows 203 and 204 are determined in step 251. The rows k 203 and k+1 204 will be referred to as the neighbor rows of row i 208 in the target image 201, or alternatively, the neighbor rows of the mapped point 202. Note that Mr(i) does not have to be an integer, and k≦Mᵣ(i)<k+1. Once the neighbor rows 203 and 204 for a particular row i 208 in the target image 201 have been determined, their values may be stored and the stored values may be used when they are needed later, instead of being recalculated.

Likewise, in step 252, the column mapping function M_{c}(j) takes a column j 207 from the target image 201 and maps it to a value between two columns l 205 and l+1 206 in the source image 200. The column mapping function M_{c}(j) can also be of any functional form, including a simple linear function. In a preferred embodiment, the column mapping function M_{c}(j) is defined by equation 4.0 as follows:

M_{c}(j)==((2*j+1)*maparray[R*16−1])/8192 (4.0)

where maparray[ ] is an array of constants whose values can be expressed in C syntax as maparray[ ]={65536, 65536, 32768, 16384, 13107, 10922, 9362, 8192, 7281, 6553, 5957, 5461, 5041, 4681, 4369, 4096}.

In order to compute the value of M_{c}(j) the expression 16R−1 is used to lookup a value in the array maparray[ ]. For instance, if R is equal to 0.25, 16R−1 will be equal to 3, and the corresponding value in maparray[ ] will be 16384 (maparray[ ] is indexed starting from zero, so this is the fourth value in the array). If 16R−1 is a non-integer, it will be rounded down to an integer. The value from maparray[ ] will be multiplied by (2*j+1), and the result will be divided by 8192.

With the value for M_{c}(j) determined, the corresponding neighbor columns 205 and 206 are determined in step 253. The columns l 205 and l+1 206 will be referred to as the neighbor columns to the column j 207 in the target image 201, or alternatively, the neighbor columns to the mapped point 202. Note that Mc(j) does not have to be an integer, and l≦M_{c}(j)<l+1. Once the neighbor columns 205 and 206 for a particular column j 207 in the target image 201 have been calculated, their values may be stored and the stored values may be used when they are needed later, instead of being recalculated.

The point 202 defined by the values of Mᵣ(i) and M_{c}(j), that is (Mᵣ(i), M_{c}(j)), is called the mapped point. The values of the row Mᵣ(i) and column M_{c}(j) for this point may not be integers, and thus it will be understood that there may not be a data element from the source image associated with the mapped point 202. Nonetheless, the mapped point 202 is useful for geometrically understanding the operation of embodiments of this invention.

In accordance with another embodiment, the neighbor rows corresponding to every row in the source image may be computed and stored at the beginning of the method. Likewise, the neighbor columns corresponding to each column in the source image may be computed and stored in the beginning of the method. Once this has been done, these stored values may be used later in the method when the neighbor rows or columns in the source data are needed for a particular row or column in the target image.

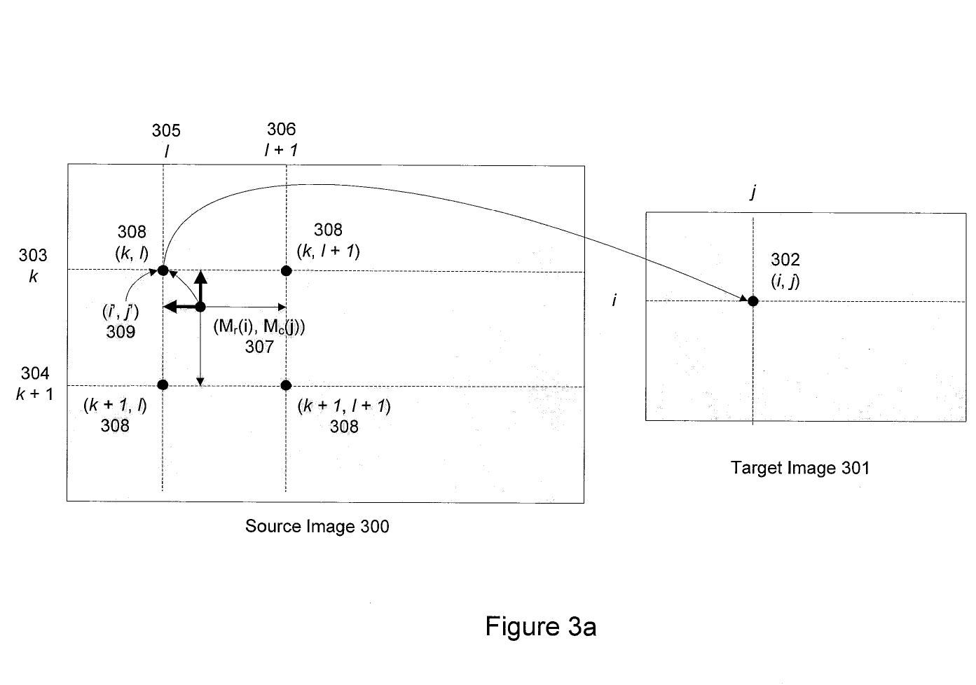

FIGS. 3a and 3b provide a more detailed illustration and discussion of steps 114 and 115 of the method 110. As depicted, FIGS. 3a and 3b illustrate the use of the neighbor rows 303 and 304, the neighbor columns 305 and 306, and the mapped point 307, to calculate the value of the data in the target image 301 at point (i,j) 302. The method advantageously allows for the calculation of the data values in the target image 301 based on the data values in the source image 300. As FIG. 1b illustrates, the method can be repeated for all points in the target image and a complete target image of the appropriate dimensions can be generated and displayed on the output device. As will be appreciated by one of ordinary skill in the art, there are a number of different orders in which the values of the data points in the target image may be computed.

In this embodiment, neighbor rows, k 303 and k+1 304, and neighbor columns, l 305 and l+1 306, are used to select a unique point (i′,j′) 309 in the source image 300. The data at point (i,j) 302 in the target image 301 is then copied from the data at point (i′,j′) 309 in the source image 300.

In step 350, the intersections of the nearest neighbor rows 303 and 304 and columns 305 and 306 define four neighbor points 308 in the source image 300 (k, l), (k+1, l), (k, l+1), and (k+1, l+1). Geometrically, the four neighbor points 308 surround the mapped point 307 defined by the possibly non-integer values of the row and column mapping functions (Mᵣ(i), M_{c}(j)). As it has non-integer row and column values, the mapped point 307 does not actually refer to a particular data element in the source image 300, but rather, it can be used to select one of the four neighbor points 308 and that point's corresponding data element using the nearest neighborhood methodology.

In order to select the source data point (i′,j′) 309 in step 351, the method may pick the point that is closest to the mapped point 307 defined by (Mᵣ(i), M_{c}(j)), the point (i′,j′) 309 also referred to as the nearest-neighbor point. The nearest neighbor point 309 is defined by the two mathematical relationships 5.0 and 6.0 as follows:

i′=k if Mᵣ(i)−k≦k+1−Mᵣ(i) (5.0)

i′=k+1 otherwise;

and

j+=l if M_{c}(j)−l≦l+1−M_{c}(j) (6.0)

j′=l+1 otherwise.

In other words, i′ equals whichever value k or k+1 is closer to Mᵣ(i), and j′ equals whichever value l or l+1 is closer to M_{c}(j).

In FIG. 3a, the nearest neighbor point 309 corresponds to the upper-left hand neighbor point (k, l) 308 because, as it is depicted in FIG. 3a, the mapped point 307 is geometrically closest to point (k, l) 308. However, as will be appreciated by one of skill in the art, this is only an illustration of one possible circumstance and the nearest neighbor point 309 could be any of the four neighbor points 308.

In step 352, once i′ and j′ have been calculated, the data in the source image 300 at the nearest neighbor point 309 (i′,j′) can be copied to the data in the target image 301 at point (i,j) 302. Repeating this process for each point (i,j) in the target image will yield a fully-formed target image of the appropriate dimensions. This method advantageously generates an image of good quality without the intensive resources demanded by prior art methods.

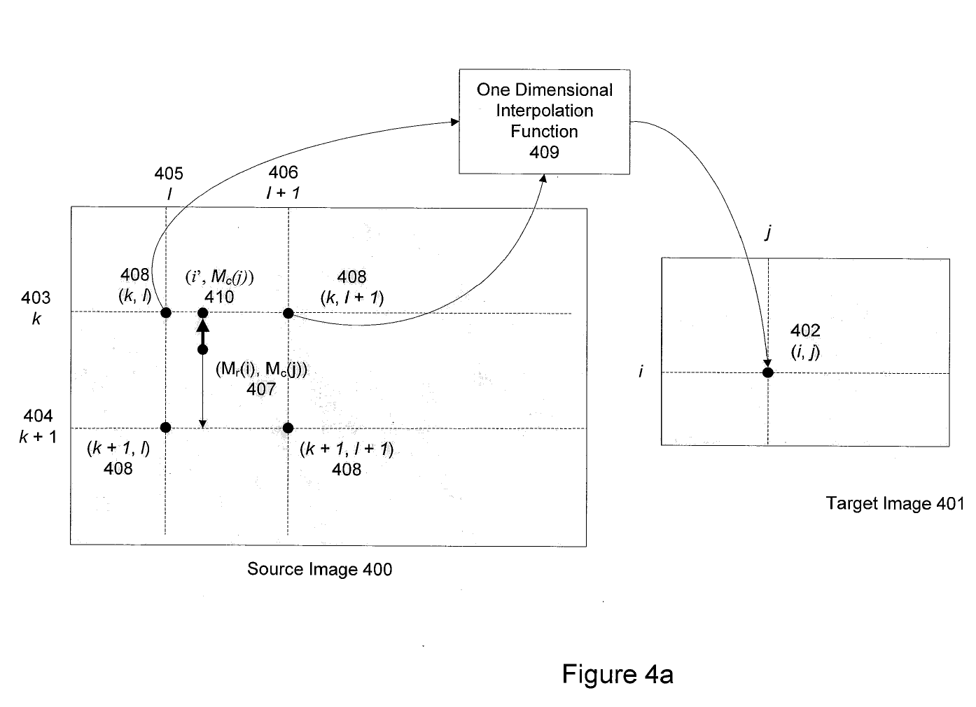

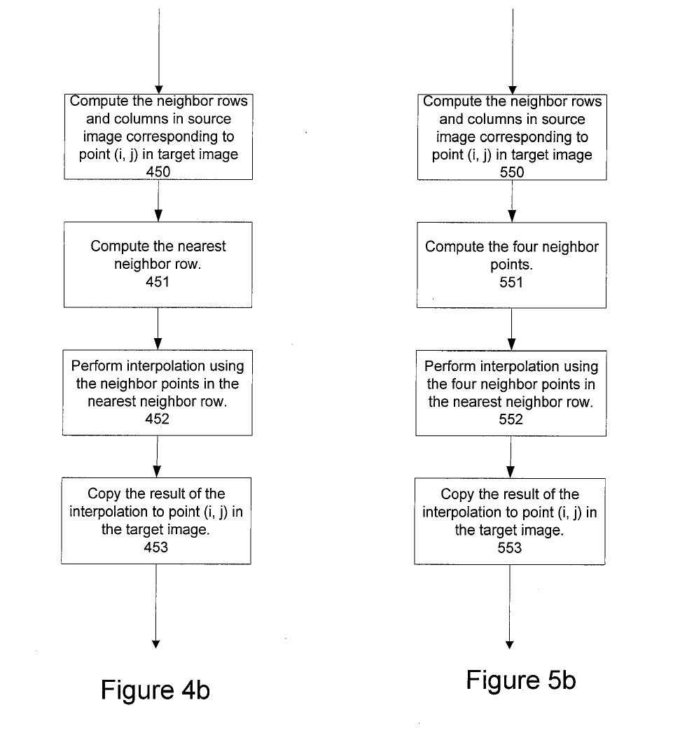

FIGS. 4a and 4b illustrate a further embodiment in which data at the intersection of one of the neighbor rows 403 or 404 and both neighbor columns 405 and 406 of the source image 400 is then passed to a one-dimensional interpolation function 409 to compute the data at point (i,j) 402 in the target image 401. By combining one-dimensional interpolation with the nearest neighbor methodology discussed above, a smoother image can be generated.

In order to compute the data in the target image 401 at point (i,j) 402, it is first necessary in step 450 to calculate the neighbor rows, k 403 and k+1 404, and neighbor columns, l 405 and l+1 406, through the use of a row mapping function Mᵣ(i) and a column mapping function M_{c}(j) preferably in accordance with the methodology described above.

Once the neighbor rows 403 and 404 and columns 405 and 406 have been calculated, step 451 selects a nearest neighbor row i′ that satisfies the following relationship 7.0:

i′=k if Mᵣ(i)−k≦k+1−Mᵣ(i) (7.0)

i′=k+1 otherwise;

### The nearest neighbor row is the row geometrically closest to the non-integer row defined by Mᵣ(i).

In FIG. 4a, the nearest neighbor row corresponds to the upper neighbor row k 403 because, as it is depicted in FIG. 4a, the mapped point 407 is geometrically closest to that row. However, as will be appreciated by one of skill in the art, this is only an illustration of one possible circumstance and the nearest neighbor row could be either of the neighbor rows 403 or 404.

Once the nearest neighbor row i′ has been determined, step 452 then performs one-dimensional interpolation using the data values in the source image 400 at the neighbor points 408 (i′, l) and 408 (i′, l+1) to compute the data value at the point (i′, M_{c}(j)) 410. This one-dimensional interpolation can be of any order, including linear interpolation. The result of this one-dimensional interpolation is copy to the target image 401 as the data at point (i,j) 402 in step 453.

With one-dimensional linear interpolation, the value of the data at point (i, j) 402 is calculated as follows:

g(i,j)=f(i′,M_{c}(j)=f(i′,l)+(M_{c}(j)−1)(f(i′,l+1)−f(i′,l)) (8.0)

In this equation 8.0 the function g(i,j) is equal to the value of the target image at point (i, j) 402, and f(x,y) is equal to the value of the source image at point (x, y). By repeating this method for all points (i,j) in the target image 401, an entire resized image of appropriate dimension can be generated.

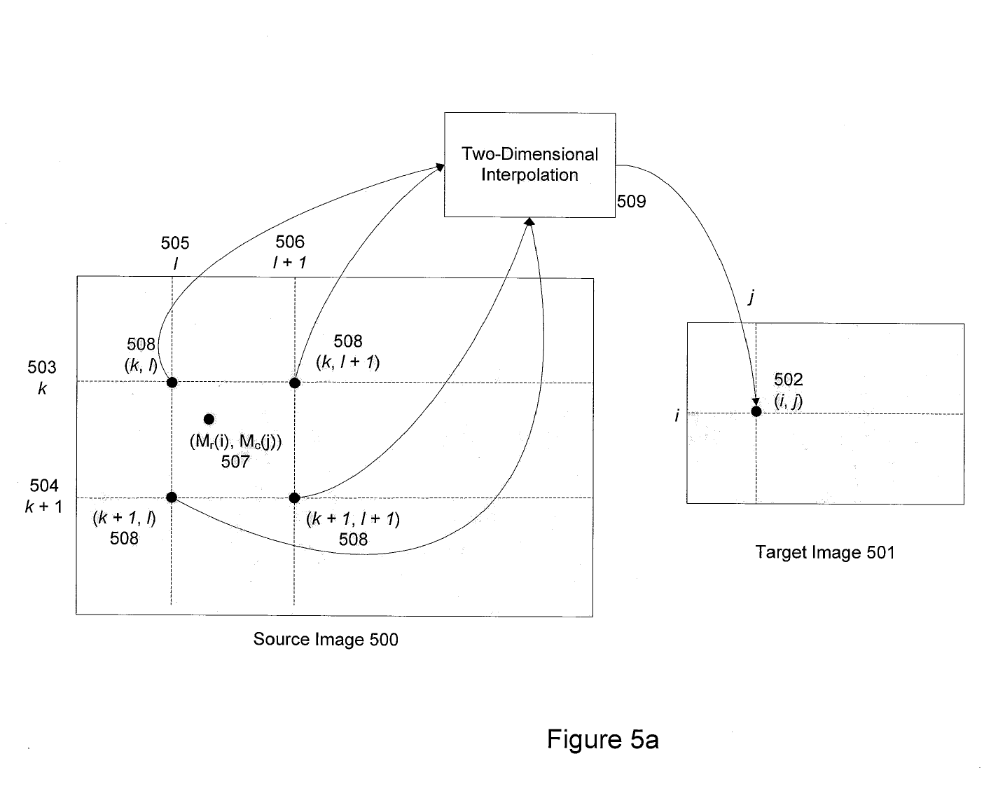

FIGS. 5a and 5b illustrate a further embodiment in which data in the four neighbor points 508 may be passed to a two-dimensional interpolation function 509 in order to compute the value of the data at point (i,j) 502 in the target image 501. By combining two-dimensional interpolation with the nearest neighbor methodology described above, an even smoother image can be generated.

To determine the value of the data at (i,j) 502 in the target image 501, the values of the neighbor rows, k 503 and k+1 504, and neighbor columns, l 505 and l+1 506, are calculated in step 550. These neighbor rows and neighbor columns may be calculated through use of the row mapping function Mᵣ(i) and a column mapping function M_{c}(j) as described in association with the embodiments disclosed above.

In step 551, the intersection of the neighbor rows 503 and 504 and neighbor columns 505 and 506 are used to uniquely define four neighbor points 508, (k, l), (k, l+1), (k+1, l), and (k+1, l+1), in the source image 500. In step 552, the values of the source image data at the neighbor points 508 can be used to perform two-dimensional interpolation in order to find the value of the data in the source image 500 at the mapped point (Mᵣ(i), M_{c}(j)) 507. This value can be copied into the target image 501 at point (i,j) 502 in step 553. With a simple two-dimensional bi-linear interpolation, the value can be calculated using equation 9.0:

$$g ( i , j ) = f ( {M}_{r} ( i ) , {M}_{c} ( j ) ) \approx ( l + 1 - {M}_{r} ( i ) ) ( k + 1 - {M}_{c} ( j ) ) f ( l , k ) + ( {M}_{r} ( i ) - l + 1 ) ( k + 1 - {M}_{c} ( j ) ) f ( l + 1 , k ) + ( l + 1 - {M}_{r} ( i ) ) ( {M}_{c} ( j ) - k ) f ( l , k + 1 ) + ( {M}_{r} ( i ) - l ) ( {M}_{c} ( j ) - k ) f ( l + 1 , k + 1 ) \qquad ( 9.0 )$$

In equation 9.0, the function g(i,j) is equal to the value of the target image at point (i,j) 502, and f(x,y) is equal to the value of the source image at point (x, y). By repeating this method for each point (i,j) in the target image 501, an entire image of the appropriate dimensions can be generated.

Although particular embodiments have been shown an described, it will be understood that the foregoing is not intended to limit the disclosure to the preferred embodiments, and it will be obvious to those skill in the art that various changes and modifications may be made without departing from the spirit and scope of the subject matter disclosed herein. Specifically, in accordance with well-known techniques of optimization within the art, certain values may be pre-computed or the results of certain computations may be cached so they may be used again later without being recalculated. These optimization techniques, as well as others known to the art, constitute obvious variations to the methods claimed and are also within the scope of this patent.

Those skilled in the art will also appreciate additional variations possible with the present techniques. For instance, these techniques may be used on one-dimensional data, such as audio data, or on data of any dimensionality. The subject matter disclosed herein is intended to cover alternatives, modifications, and equivalents, which may be included within the spirit and scope of the claims.

What is claimed is:

1. A method for resizing a source image to a target image comprising the steps of:
(a) computing first and second neighbor rows in a source image corresponding to a selected row in a target display;
(b) computing first and second neighbor columns in the source image corresponding to a selected column in the target display;
(d) computing a mapped point in the source image corresponding to an intersection of the selected row and column in the target display;
(e) computing the value of a data element for a target image at the intersection of the selected row and column in the target display as a function of the mapped point and at least one of the first and second neighbor rows and columns nearest to the mapped point; and
(f) repeating steps (a) through (e) for each intersection of each row and column combination in the target display.

2. The method of claim 1 wherein step (d) comprises:
mapping the selected row in the target display to a mapped row in the source image;
mapping the selected column in the target display to a mapped column in the source image; and
computing an intersection of the mapped row and column.

3. The method of claim 2 wherein the step of mapping the selected row comprises using a row mapping function.

4. The method of claim 3 wherein the row mapping function is defined as Mᵣ(i)=((2*i+1)*maparray[16*R−1])/8192; where maparray[ ] is an array of constants.

5. The method of claim 2 wherein the step of mapping the selected column comprises using a column mapping function.

6. The method of claim 5 wherein the column mapping function is defined as M_{c}(j)=((2*j+1)*maparray[16R−1])/8192; where maparray[ ] is an array of constants.

7. The method of claim 1 wherein step (e) comprises:
computing first, second, third and fourth neighbor points, wherein the first, second, third and fourth neighbor points are located at intersections of the first and second neighbor rows and columns;
computing a nearest neighbor point, wherein the nearest neighbor point is one of the first, second, third and fourth neighbor points which is geometrically closest to the mapped point; and
copying the value of the data element from the nearest neighbor point to a target image at the intersection of the selected row and column in the target display.

8. The method of claim 1 wherein step (e) comprises:
computing the nearest neighbor row in the source data, wherein the nearest neighbor row is the one of the first and second neighbor rows geometrically closest to the mapped point;
performing a one-dimensional interpolation using the value of data elements at intersections of the nearest neighbor row and the first and second neighbor columns to compute the value of a data element at an intersection of the nearest neighbor row and a column corresponding to the mapped point; and
copying the value of the data element at the intersection of the nearest neighbor row and the column corresponding to the mapped point to a target image at an intersection of the selected row and column in the target display.

9. The method of claim 1 wherein step (e) comprises:
computing first, second, third and fourth neighbor points, wherein the first, second, third and fourth neighbor points are located at the intersections of the first and second neighbor rows and columns;
performing a two-dimensional interpolation using the value of data elements at the first, second, third and fourth neighbor points and the mapped point; and
copying the results of the two-dimensional interpolation to a target image at an intersection of the selected row and the column in the target display.

10. A method for resizing a source image to a target image comprising the steps of:
(a) computing first and second neighbor rows in a source image corresponding to a selected row in a target display;
(b) storing the first and second neighbor rows in memory;
(c) repeating steps (a) and (b) for each row in the target display;
(d) computing first and second neighbor columns in the source image corresponding to a selected column in the target display;
(e) storing the first and second neighbor columns in memory;
(f) repeating steps (d) and (e) for each column in the target display;
(g) computing a mapped point in the source image corresponding to an intersection of a selected row and a selected column in the target display;
(h) computing the value of a data element for a target image at the intersection of a selected row and a selected column in the target display as a function of the mapped point and at least one of the stored first and second neighbor rows and columns nearest to the mapped point; and
(i) repeating steps (g) and (h) for each intersection of each row and column combination in the target display.

11. The method of claim 10 wherein step (g) comprises:
mapping a selected row in the target display to a mapped row in the source image;
mapping a selected column in the target display to a mapped column in the source image; and
computing an intersection of the mapped row and column.

12. The method of claim 11 wherein the step of mapping the selected row comprises using a row mapping function.

13. The method of claim 12 wherein the row mapping function is defined as Mᵣ(i)=((2*i+1)*maparray[16*R−1])/8192; where maparray[ ] is an array of constants.

14. The method of claim 11 wherein the step of mapping the selected column comprises using a column mapping function.

15. The method of claim 14 wherein the column mapping function is defined as M_{c}(j)=((2*j+1)*maparray[16R−1])/8192; where maparray[ ] is an array of constants.

16. The method of claim 10 wherein step (h) comprises:
computing first, second, third and fourth neighbor points, wherein the first, second, third and fourth neighbor points are located at the intersections of the stored first and second neighbor rows and columns;
computing a nearest neighbor point, wherein the nearest neighbor point is one of the first, second, third and fourth neighbor points which is geometrically closest to the mapped point;
copying the value of the data element from the nearest neighbor point to a target image at the intersection of the selected row and column in the target display.

17. The method of claim 10 wherein step (h) comprises:
computing a nearest neighbor row in the source image, wherein the nearest neighbor row is one of the stored first and second neighbor rows geometrically closest to the mapped point;
performing a one-dimensional interpolation using the value of data elements at intersections of the nearest neighbor row and the stored first and second neighbor columns geometrically closest to the mapped point to compute the value of a data element at an intersection of the nearest neighbor row and a column corresponding to the mapped point; and
copying the value of the data element at the intersection of the nearest neighbor row and the column corresponding to the mapped point to a target image at an intersection of a selected row and a selected column in the target display.

18. The method of claim 10 wherein step (h) comprises:
computing first, second, third and fourth neighbor points, wherein the first, second, third and fourth neighbor points are located at the intersections of the stored first and second neighbor rows and columns corresponding to selected row and columns in the target display;
performing a two-dimensional interpolation using the value of data elements at the first, second, third and fourth neighbor points and the mapped; and
copying the results of the two-dimensional interpolation to a target image at an intersection of the selected row and the column in the target display.

19. A device capable of resizing a source image to a target image for display on the device comprising:
a display for viewing a target image, and
processing engine computing the value of a data element for a target image at an intersection of a selected row and a selected column of the target image as a function of a mapped point in a source image corresponding to the intersection of the selected row and column and at least one of first and second neighbor rows and columns nearest to the mapped point.

20. The device of claim 19 wherein the processing engine comprises a CPU, non-volatile memory and a software program stored in the memory and executable by the CPU.

21. The device of claim 19 wherein the processing engine comprises an application-specific integrated circuit.

22. The device of claim 19 wherein the processing engine comprises a field programmable gate array.

23. The device of claim 19 wherein the processing engine comprises a programmable logic device.

24. The device of claim 19 wherein computing the value of a data element includes computing the first and second neighbor rows in the source image corresponding to the selected row in the target image.

25. The device of claim 24 wherein computing the value of a data element includes computing first and second neighbor columns in the source image corresponding to the selected column in the target image.

26. The device of claim 19 wherein computing the value of a data element includes computing the mapped point in the source image corresponding to the intersection of the selected row and column in the target image.

27. The device of claim 26 wherein computing the mapped point includes mapping the selected row and column in the target image to a mapped row and a mapped column in the source image and computing an intersection of the mapped row and column.

28. The device of claim 27 wherein the selected row is mapped using a row mapping function.

29. The device of claim 28 wherein the row mapping function is defined as Mᵣ(i)=((2*i+1)*maparray[16*R−1])/8192; where maparray[ ] is an array of constants.

30. The method of claim 28 wherein the selected column is mapped using a column mapping function.

31. The device of claim 30 wherein the column mapping function is defined as M_{c}(j)=((2*j+1)*maparray[16R-1])/8192; where maparray[ ] is an array of constants.

32. The method of claim 25 wherein computing the value of a data element includes
computing first, second, third and fourth neighbor points, wherein the first, second, third and fourth neighbor points are located at intersections of the first and second neighbor rows and columns;
computing a nearest neighbor point, wherein the nearest neighbor point is one of the first, second, third and fourth neighbor points which is geometrically closest to the mapped point; and
copying the value of the data element from the nearest neighbor point to a target image at the intersection of the selected row and column in the target display.

33. The method of claim 25 wherein computing the value of a data element includes
computing the nearest neighbor row in the source data, wherein the nearest neighbor row is the one of the first and second neighbor rows geometrically closest to the mapped point;
performing a one-dimensional interpolation using the value of data elements at intersections of the nearest neighbor row and the first and second neighbor columns to compute the value of a data element at an intersection of the nearest neighbor row and a column corresponding to the mapped point; and
copying the value of the data element at the intersection of the nearest neighbor row and the column corresponding to the mapped point to a target image at an intersection of the selected row and column in the target display.

34. The method of claim 25 wherein computing the value of a data element includes
computing first, second, third and fourth neighbor points, wherein the first, second, third and fourth neighbor points are located at the intersections of the first and second neighbor rows and columns;
performing a two-dimensional interpolation using the value of data elements at the first, second, third and fourth neighbor points and the mapped point; and
copying the results of the two-dimensional interpolation to a target image at an intersection of the selected row and the column in the target display.
